(19) United States
(12) Patent Application Publication
(10) Pub. No.: US 2006/0010793 A1
(43) Pub. Date: Jan. 19, 2006

(54) Indexing ribs for assembling a door, and door

(76) Inventor: Ralph A. Martino, Tampa, FL (US)

Correspondence Address: Joseph W. Berenato, III;Liniak, Berenato & White, LLC, Suite 240, 6550 Rock Spring Drive, Bethesda, MD, 20817, US

(21) Appl. No.: 10/891,490

(22) Filed: Jul. 15, 2004

(51) Int. Cl. E06B 1/04

(52) U.S. Cl. 52/204.1

(57) ABSTRACT

The present invention is directed to a door having indexing ribs for aligning the door components during assembly. A peripheral door frame is provided having first and second stiles and first and second rails. The stiles and rails have opposing first and second sides. At least one channel is disposed in at least one of the sides. The channel has a base and angled sidewalls extending outwardly from the base to a corresponding side. The interior surfaces of first and second door facings are aligned with and secured to the first and second sides of the frame, respectively. At least one of the door facings has a ridge extending outwardly from its interior surface. The ridge is aligned with and received in the channel.

### FIELD OF THE INVENTION

The present invention is directed to a door having indexing ribs for aligning the door components during assembly. A peripheral door frame is provided having first and second stiles and first and second rails. The stiles and rails have opposing first and second sides. At least one channel is disposed in at least one of the sides. The channel has a base and angled sidewalls extending outwardly from the base to a corresponding one of the sides. The interior surfaces of first and second door facings are aligned with and secured to the first and second sides of the frame, respectively. At least one of the door facings has an indexing rib extending outwardly from its interior surface. The rib is aligned with and received in the channel.

### BACKGROUND OF THE INVENTION

Molded doors are assembled using two door facings, which are typically secured to opposing sides of an internal frame that provides structural support. The frame typically includes stiles and rails located around the perimeter of the door. The facings may be molded from a wood fiber and resin composite, or a thermoset thermoplastic or thermoset composite material, such as a fiberglass compound. The door may also include a core material.

Thermoset thermoplastic or thermoset composite door facings typically are oversized during molding (i.e. out-of-press) compared to many frame sizes. The facings are then trimmed to accommodate the size of the frame to which the facings are to be secured. In this way, the same molded facing may be used for a variety of door sizes, and the manufacturer can be sure that the facing has at least the size required for the frame. Generally, a thermoset thermoplastic or thermoset composite door facing cannot be reused if it is not of sufficient size.

After the facings are trimmed to match a particular frame, they are carefully positioned on the frame, a process sometimes referred to as door lay-up. If the facings are not properly aligned with the corresponding frame, the edges of the resulting door may appear misaligned, rendering the door commercially unacceptable. In addition, if the facings are not properly trimmed, the appearance of the edges of the resulting door may be unacceptable. Therefore, accurate trimming of the facings prior to lay-up is required. Furthermore, careful alignment of the trimmed door facings onto the corresponding door frame is required. The trimming and alignment processes are relatively labor intensive, expensive, and subject to quality variations.

In an attempt to control product quality, various attempts have been made to effect proper positioning during door lay-up. Some attempts provide for door facings with hooked or L-shaped edges, which clip around the outermost portion of a perimeter frame. However, such designs do not ensure that the facings will be properly aligned unless they also are carefully molded to fit the frame prior to door lay-up. Other efforts include channels formed in the frame to receive a rib extending from the door facing. These efforts require precise control over the size and shape of the channel and rib, and also orientation of the rib with the channel. Such methods have not proven to be practical for door manufacture using thermoset thermoplastic or thermoset composite door facings, which are typically oversized out-of-press.

Therefore, there is a need for a door facing that is easily aligned with the frame during assembly.

### SUMMARY OF THE INVENTION

The present invention is directed to a door. The door includes a peripheral door frame having first and second stiles and first and second rails. The stiles and rails have opposing first and second sides. At least one channel is disposed in at least one of the sides. The channel has a base and angled sidewalls extending outwardly from the base to the side. First and second door facings having interior surfaces are aligned with and secured to the first and second sides of the frame, respectively. At least one of the door facings has a ridge extending outwardly from the interior surface. The ridge is aligned with and received in the channel.

The present invention is also directed to a door facing. The facing comprises a generally rectangular member having first and second opposing major surfaces. The first major surface is adapted to be exteriorly disposed and the second major surface is adapted to be secured to a peripheral door frame. A series of spaced ridges are provided that extend outwardly from the second major surface, and are spaced from and parallel to a perimeter of the rectangular member. Each one of the spaced ridges has a semi-circular configuration in section.

The present invention also relates to a method of assembling a door. A peripheral door frame having opposing first and second sides and a channel disposed in each of the sides is provided. The channel has a base and angled sidewalls extending outwardly from the base to the side. First and second door facings are provided. Each facing has a ridge extending outwardly from an interior surface thereof. The ridge has a semi-circular configuration in section and extends outwardly from the interior surface to an apex of the ridge. The apex of the first facing is aligned with the channel in the first side. The first facing is positioned onto the first side by sliding the ridge into the channel until the apex is adjacent the base. The apex of the second facing is aligned with the channel in the second side. The second facing is positioned onto the second side by sliding the ridge into the channel until the apex is adjacent the base. The facings and frame are compressed to form a door.

### BRIEF DESCRIPTION OF THE FIGURES

FIG. 1 is a perspective view of a door according to a first embodiment of the present invention;

FIG. 2 is a cross-sectional view of a portion of the door of FIG. 1 taken along line 2-2 and viewed in the direction of the arrows;

FIG. 3 is an assembly view of the door shown in FIG. 1;

FIG. 4 is a fragmentary sectional view of a portion of the door shown in FIG. 1 taken along lines 4-4 and viewed in the direction of the arrows prior to compressing and trimming the door;

FIG. 5 is a fragmentary sectional view of a portion of a door similar to the view shown in FIG. 4 with facings according to another embodiment; and

FIG. 6 is an elevational view of an interior surface of a facing showing ridge placement according to a preferred embodiment.

### DETAILED DESCRIPTION OF THE INVENTION

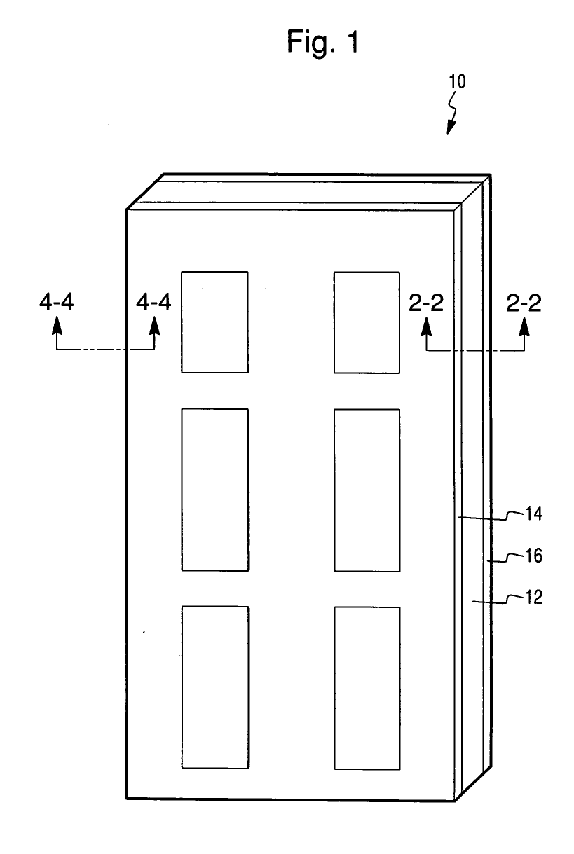

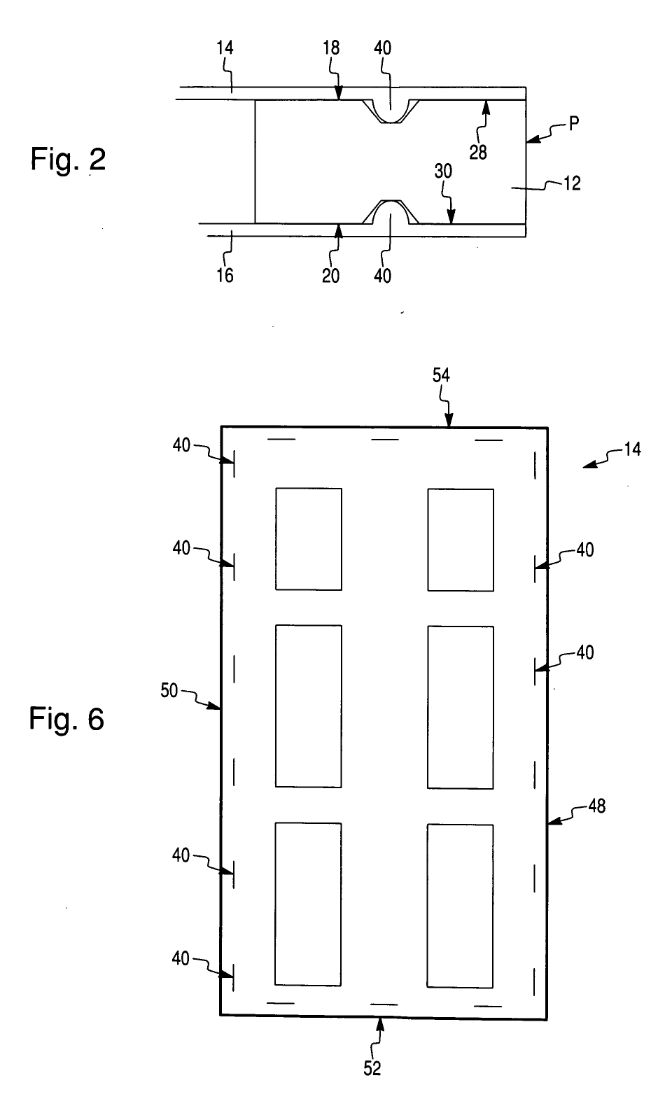

As best shown in FIGS. 1 and 2, a door 10 according to the present invention includes a peripheral door frame 12, with first and second door facings 14, 16 secured to opposing first and second sides 18, 20 of frame 12, respectively. Preferably, first and second door facings 14, 16 are molded thermoset thermoplastic or thermoset composite door facings, such as fiberglass door facings. However, first and second door facings 14, 16 may also be molded wood composite facings, such as medium density fiberboard door facings.

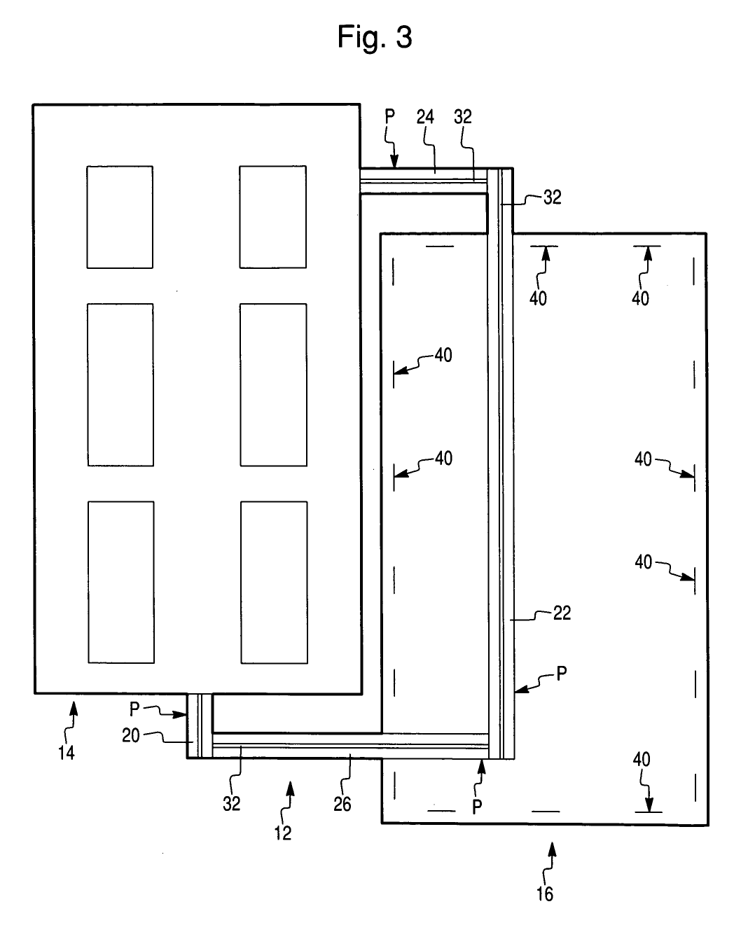

As best shown in FIG. 3, frame 12 includes first and second stiles 20, 22 and first and second rails 24, 26. Stiles 20, 22 may be laminated stiles having a composite core and solid wood outer edges. The composite core may be formed from fiberboard, wood fiber/resin composite material, plastic/wood fiber material, plastic/wood flour composite material, or any other suitable composite material. Alternatively, stiles 20, 22 may be formed from solid wood, or formed from a composite material without solid wood edges. Rails 24, 26 may also be formed from a composite material, such as fiberboard, wood fiber/resin composite material, plastic/wood fiber material, plastic/wood flour composite material, or any other suitable composite material. Alternatively, rails 24, 26 may be formed from solid wood.

First and second door facings 14, 16 are adhesively secured to opposing sides of the door frame 12, as best shown in FIGS. 1 and 2. An interior surface 28 of facing 14 is secured to first side 18 of frame 12. An interior surface 30 of facing 16 is secured to second side 20. Facings 14, 16 are preferably adhesively secured to frame 12.

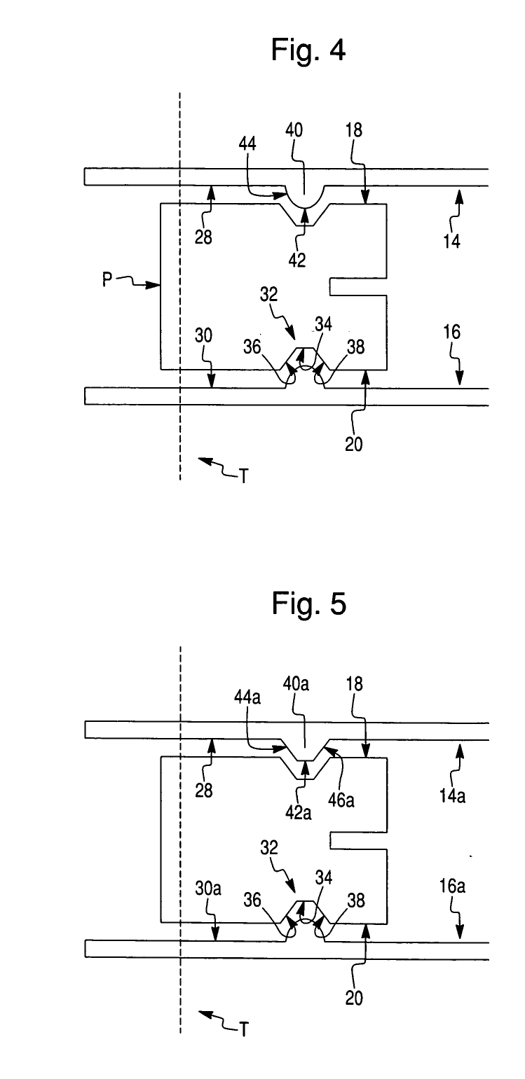

At least one groove or channel 32 is formed in at least one of sides 18, 20, as best shown in FIG. 4. Channel 32 may be routed, machined or molded into sides 18, 20, depending on the construction of stiles 20, 22 and rails 24, 26 as well as manufacture preference. Channel 32 includes a base 34, and angled sidewalls 36, 38 extending outwardly from base 34 to the corresponding side 18 or 20. Preferably, angled sidewalls 36, 38 extend outwardly from base 34 at an angle of at least about 30°, more preferably at least about 45°, relative to side 18 or 20. Preferably channel 32 is formed on opposing sides 18, 20 of each of stiles 20, 22 and rails 24, 26. However, it should be understood that channel 32 may be formed in only one of sides 18, 20. Alternatively, channel 32 may be formed in one or both sides of only stiles 20, 22, or one or both sides of only rails 24, 26.

As best shown in FIGS. 2 and 4, facings 14, 16 include indexing ribs or ridges 40 with a semi-circular configuration in section. Ridges 40 extend outwardly from interior surfaces 28, 30 to an outermost portion or apex 42. Ridges 40 are aligned with and received in corresponding channels 32 during the door lay-up process. Due to the curved walls 44 of ridges 40, ridges 40 tend to slide against angled sidewalls 36, 38 until apex 42 is adjacent base 34, as best shown in FIG. 2. Interior sides 28, 30 of facings 14, 16 are preferably flush with sides 18, 20 of frame 12, respectively, when apex 42 of ridges 40 are positioned in channels 32.

Although channels 32 preferably include angled sidewalls 36, 38, it would be apparent to one skilled in the art that channels 32 could have other configurations. Frame 12 may include channels having a complimentary configuration compared to the configuration of ridges 40. For example, channels having a semi-circular configuration in section may be provided, which are complimentary to the configuration of ridges 40. Alternatively, channels may be substantially rectangular in section. However, channels having angled or curved sidewalls tend to guide ridges 40 into proper position, even if facings 14, 16 are not precisely aligned with frame 12.

Facings 14a, 16a having ridges 42a according to another embodiment are best shown in FIG. 5. Ridges 40a extending outwardly from interior surfaces 28a, 30a. Each ridge 40a has a configuration corresponding to and complementary with the contour of channel 32. Ridge 40a is aligned with and received in the corresponding channel 32 during the door lay-up process. Ridges 40a are formed in facings 14a, 16a to correspond to channels 32, and include a crest 42a and angled sides 44a, 46a connected to and integral with crest 42a and interior surfaces 28a, 30a. Sides 44a, 46a preferably extend at an angle of at least about 30° relative to interior surface 28a or 30a. More preferably, sides 44a, 46a extend at substantially the same angle as angled sidewalls 36, 38.

As best shown in FIG. 6, facings 14 (or 14a) preferably include a series of ridges 40 (or 40a) spaced from and parallel to the facing periphery. A plurality of relatively short ridges 40 permits a desired amount of flexibility of facing 14. Some flexibility of facing 14 may be desirable if door 10 is prone to bowing slightly. For example, a certain amount of bowing of door 10 may be caused by thermal and/or moisture fluctuations. Accordingly, facing 16 has a ridge placement similar or identical to the ridge placement on facing 14. If ridges 40 do not permit a sufficient amount flex when door 10 bows, facings 14, 16 may crack in portions not strengthened by ridges 40 (i.e. such as in the corners and/or central portions of door 10).

A series of relatively short ridges 40 proximate each edge 48, 50, 52, 54 permits a sufficient amount of flexibility of facing 14 (or 16). However, a sufficient number of ridges 40 should be provided proximate edges 48, 50, 52, 54 of facings 14, 16 to ensure that facings 14, 16 are easily aligned with channels 32. In addition, each ridge 40 should have a sufficient length to ensure that it may be easily aligned within channels 32, while still maintaining the proper position of facings 14, 16 on frame 12. A sufficient number of ridges 40 having a sufficient length also provide structural integrity to facings 14, 16.

An exemplary placement of ridges 40 on facing 14 is best shown in FIG. 6. Facing 14 includes six relatively short ridges 40 (or 40a) spaced from and parallel to edges 48, 50. Facing 14 also includes three relatively short ridges 40 (or 40a) spaced from and parallel to edges 52, 54. It should be understood that fewer or more ridges may be provided proximate each edge 48, 50, 52 or 54. Furthermore, facing 14 need not include the same number of ridges 40 (or 40a) proximate edge 48 compared to edge 50, or edge 52 compared to edge 54. The length of ridges 40 (or 40a) may also vary depending on the number of ridges provided. However, ridges 40 (or 40a) preferably have a length of at least about one inch, more preferably at least about two inches.

If one relatively long ridge 40 (or 40a) extended proximate and parallel to each edge 48, 50, 52, 54 of facing 14, whereby the length of ridge 40 (or 40a) was substantially the same as the corresponding edge 48, 50, 52 or 54, flexibility of facing 14 may be limited. However, it should be understood that such a configuration for ridges 40 (or 40a) may be appropriate if bowing is not a consideration. One relatively long ridge 40 (or 40a) proximate each corresponding edge 48, 50, 52, 54 may be appropriate for some applications.

Facing 16 also preferably includes the same placement of ridges 40 as described above for facing 14, as best shown in FIG. 3. Channels 32 are formed in first and second sides 18, 20 of frame 12, as described above. Preferably, channels 32 are spaced from and parallel to the periphery P of frame 12, as best shown in FIGS. 2 and 4. Channels 32 formed in first side 18 are preferably aligned with channels 32 formed in second side 20. Channels 32 preferably extend the entire length of stiles 20, 22 and rails 24, 26, as best shown in FIG. 3. In this way, ridges 40 (or 40a) may be easily aligned with channels 32, even if facings 14, 16 are slightly different in size.

Ridges 40 (or 40a) are preferably formed on facings 14, 16 while facings 14, 16 are being molded. However, ridges 40 may also be separately formed, and adhered to conventional facings to form facings 14, 16. Thermoset thermoplastic or thermoset composite door facings are typically oversized out-of-press, compared to the size of many doorframes. However, facings 14, 16 need not be trimmed prior to door lay-up because precise placement of facings 14, 16 on frame 12 is achieved by aligning ridges 40 with channels 32. First facing 14 is positioned so that its interior surface 28 is exposed. First side 18 of frame 12 is aligned with facing 14 so that channels 32 are aligned with ridges 40. Because of the curvilinear configuration of walls 44 and the angular configuration of sidewalls 36, 38 of channels 32, frame 12 tends to slide into proper position on facing 14 even if ridges 40 are slightly misaligned with channels 32. Ridges 40 tend to slide against sidewalls 36, 38 until apex 42 (or crest 42a) is aligned with and preferably contacts base 34, as best shown in FIG. 2. Second facing 16 may then be aligned with second side 20 of frame 12 in the same manner. Facings 14, 16 are preferably adhesively secured to frame 12, though fasteners such as screws may also be used.

Thus, channels 32 and ridges 40 provide a tongue and groove door assembly system, which may be used to easily locate and align the facings 14, 16 on the stiles 20, 22 and rails 24, 26 during lay-up. After facings 14, 16 are properly aligned with frame 12, the resulting components may be compressed to form door 10, as best shown in FIG. 1.

The perimeter of door 10 may then be trimmed to a desired size, as shown by trim line T in FIGS. 4 and 5. Thus, facings 14, 16 need not be precisely sized prior to door lay-up. Note that a portion of both the facings 14, 16, as well as the perimeter P of frame 12 may be trimmed to size without removing ridges 40 and channels 32.

The present invention therefore eliminates the need for pre-trimming facings prior to lay-up, thereby decreasing manufacturing costs. For example, the present invention reduces manufacturing costs, and reduces manufacturing time, compared to the cost and time for manufacturing a similar door that does not include channels 32 and ridges 40. In addition, facings 14, 16 require less handling, which reduces the possibility of damage. It will be understood to one skilled in the art that the present invention is applicable to any type of door, including interior doors, exterior entry doors, and cabinet doors for furniture, kitchen cabinets, and the like.

Certain aspects of the present invention have been explained according to preferred embodiments. However, it will be apparent to one of ordinary skill in the art that various modifications and variations of the disclosed embodiments may be made without departing from the scope or spirit of the invention. Thus, it is intended that the present invention cover all such modifications and variations, provided they come within the scope of the following claims and their equivalents.

We claim as follows:

1. A door, comprising:
a peripheral door frame having first and second stiles and first and second rails, said stiles and said rails having opposing first and second sides;
at least one channel disposed in at least one of said sides, said channel having a base and angled sidewalls extending outwardly from said base to said side; and
first and second door facings having interior surfaces aligned with and secured to said first and second sides, respectively, at least one of said door facings having a ridge extending outwardly from said interior surface, said ridge aligned with and received in said channel.

2. The door of claim 1, wherein said first and second stiles each include said channel disposed in said first side thereof.

3. The door of claim 2, wherein said first and second stiles each include said channel disposed in said second side thereof.

4. The door of claim 3, wherein said channels are parallel to and spaced from outer edges of said stiles.

5. The door of claim 4, further comprising a plurality of spaced ridges spaced from and parallel to said outer edges of said stiles.

6. The door of claim 5, wherein each of said ridges is semi-circular in section.

7. The door of claim 5, wherein each of said ridges includes an outer portion and sidewalls connected to and integral with said outer portion and said interior surface.

8. The door of claim 23, wherein said sidewalls extend outwardly from said outer portion to said interior surface at an angle of at least about 30° relative to said interior surface.

9. The door of claim 1, wherein said first and second rails each include said channel disposed in said first side thereof.

10. The door of claim 9, wherein said first and second rails each include said channel disposed in said second side thereof.

11. The door of claim 10, wherein said channels are parallel to and spaced from outer edges of said rails.

12. The door of claim 11, further comprising a plurality of spaced ridges spaced from and parallel to said outer edges of said rails.

13. The door of claim 12, wherein each of said ridges is semi-circular in section.

14. The door of claim 12, wherein each of said ridges includes an outer portion and sidewalls connected to and integral with said outer portion and said interior surface.

15. The door of claim 14, wherein said sidewalls extend outwardly from said outer portion to said interior surface at an angle of at least about 30° relative to said interior surface.

16. The door of claim 1, wherein each of said stiles and each of said rails include a first channel disposed in said first side and second channel disposed in said second side, wherein each channel is spaced from and parallel to an outer periphery of said frame.

17. The door of claim 16, wherein said first door facing includes at least two spaced ridges received in each of said first and second channels.

18. The door of claim 1, wherein at least one of said door facings is formed from one of a thermoset composite material and a thermoset thermoplastic material.

19. The door of claim 16, wherein at least one of said door facings is a fiberglass door facing.

20. The door of claim 1, wherein said stiles are laminated stiles having a composite core and solid wood outer edges.

21. The door of claim 1, wherein said stiles are formed from a composite material.

22. The door of claim 1, wherein said stiles are solid wood.

23. The door of claim 1, wherein said rails are formed from a composite material.

24. The door of claim 1, wherein said rails are solid wood.

25. A door facing, comprising:
a generally rectangular member having first and second opposing major surfaces, said first major surface adapted to be exteriorly disposed and said second major surface adapted to be secured to a peripheral door frame;
a series of spaced ridges extending outwardly from said second major surface and spaced from and parallel to a perimeter of said rectangular member, each one of said spaced ridges having a semi-circular configuration in section.

26. The door facing of claim 25, wherein each of said spaced ridges has a length of at least about 2 inches.

27. The door facing of claim 25, wherein said rectangular member is formed from one of a thermoset thermoplastic material and a thermoset composite material.

28. A method of assembling a door, comprising the steps of:
providing a peripheral door frame having opposing first and second sides and a channel disposed in each of the sides, the channel having a base and angled sidewalls extending outwardly from the base to the side;
providing first and second door facings, each facing having a ridge extending outwardly from an interior surface thereof, the ridge having a semi-circular configuration in cross-section and extending outwardly from the interior surface to an apex of the ridge;
aligning an apex of the first facing with the channel in the first side;
positioning the first facing onto the first side by sliding the ridge into the channel until the apex is adjacent the base;
aligning the apex of the second facing with the channel in the second side;
positioning the second facing onto the second side by sliding the ridge into the channel until the apex is adjacent the base;
compressing the facings and frame to form a door.

29. The method of claim 28, comprising the further step of trimming an outer edge of the door.
